(19) United States
(12) Patent Application Publication
(10) Pub. No.: US 2004/0163485 A1
(43) Pub. Date: Aug. 26, 2004

(54) Dual throttle

(76) Inventor: Michael S. Ginnetti, Winthrop, MA (US)

Correspondence Address: LITMAN LAW OFFICES, LTD., P.O. BOX 15035 CRYSTAL CITY STATION, ARLINGTON, VA, 22215, US

(21) Appl. No.: 10/372,780

(22) Filed: Feb. 26, 2003

(51) Int. Cl. G05G 11/00

(52) U.S. Cl. 74/488

(57) ABSTRACT

A throttle adapted for use on recreational vehicles, especially personal watercraft such as jet skies. The throttle is mounted on a handlebar of a jet ski preferably adjacent the engine on/off switch. The throttle is provided with a quick-release mechanism. Actuation of the mechanism permits the throttle to be moved from a thumb-activated position to a fingers-operated position. Deactivation of the mechanism will lock the throttle to the handlebar in either of the aforementioned positions.

### BACKGROUND OF THE INVENTION

1. Field of the Invention

The present invention generally relates to speed control devices. More specifically, the present invention is drawn to an adjustable throttle adapted for mounting to a personal watercraft.

2. Description of the Related Art

Participation in water sports continues to be a popular attraction for vacationers and the like. One of the more exciting forms of water sports involves personal watercrafts such as jet skis. This form has spawned a new industry in that many participants purchase or plan to purchase a personal jet ski. All is not perfect, however. Unfortunately, most jet skiers encounter a common problem known as the “achy thumb syndrome”.

The throttle on a jet ski is positioned so that it may be engaged either by the fingers or the thumb, depending on the design of the particular ski. After riding for as little as ten minutes, holding the throttle to accelerate begins to cause the fingers or thumb to ache. Often the pain is such that the rider has to pause for an extended rest, rudely interrupting the fun and exhilaration of the moment. Any invention that would alleviate this scenario would certainly be a welcome addition to the art.

The prior art abounds with disclosures that show control devices mounted on handlebars. For example, U.S. Pat. No. 4,222,285 (Kine), U.S. Pat. No. 4,304,146 (Ueda) and U.S. Pat. No. 4,459,871 (Shimano) all show brake devices mounted on bicycle handlebars. Each of the disclosed devices is disposed in a position to be engaged by the bike rider's fingers. The patentees do not contemplate moving the devices to a position whereby they may be engaged by the rider's thumb.

U.S. Pat. No. 5,078,023 (Scarborough) discloses a thumb-operated throttle for recreational vehicles. The throttle comprises primary and secondary levers to ease the required thumb force. There is no structure to move the throttle to a finger-operated position.

U.S. Pat. No. 6,318,490 is drawn to a motorcycle cruise control device. There is no consideration given for moving the device to alternate positions.

None of the above inventions and patents, taken either singly or in combination, is seen to disclose a throttle which may be easily moved to an alternative operating position as will be subsequently described and claimed in the instant invention.

### SUMMARY OF THE INVENTION

The present invention is drawn to a throttle adapted for use on recreational vehicles, especially personal watercraft such as jet skies. The throttle is mounted on a handlebar of a jet ski, preferably adjacent the engine on/off switch. The throttle is provided with a quick-release mechanism. Actuation of the mechanism permits the throttle to be moved from a thumb-activated position to a finger-operated position. Deactivation of the mechanism will lock the throttle to the handlebar in either of the aforementioned positions.

Accordingly, it is a principal object of the invention to provide an improved throttle arrangement for a watercraft.

It is another object of the invention to provide an improved throttle arrangement for a watercraft, which throttle may be operated in either of two positions.

It is a further object of the invention to provide an improved throttle arrangement for a watercraft, which throttle may be operated by the fingers of a user.

Still another object of the invention is to provide an improved throttle arrangement for a watercraft, which throttle may be operated by the thumb of a user.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a dual throttle mechanism according to the present invention.

FIG. 2 is a plan view of a dual throttle mechanism according to the present invention.

Similar reference characters denote corresponding features consistently throughout the attached drawings.

### DETAILED DESCRIPTION OF THE PREFERRED EMBODIMENT

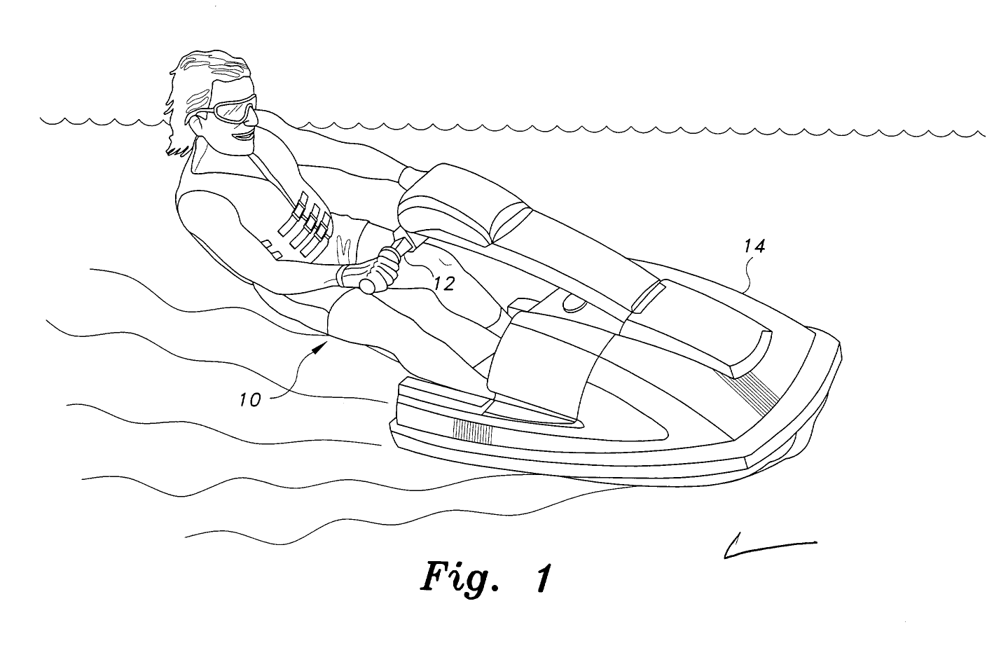

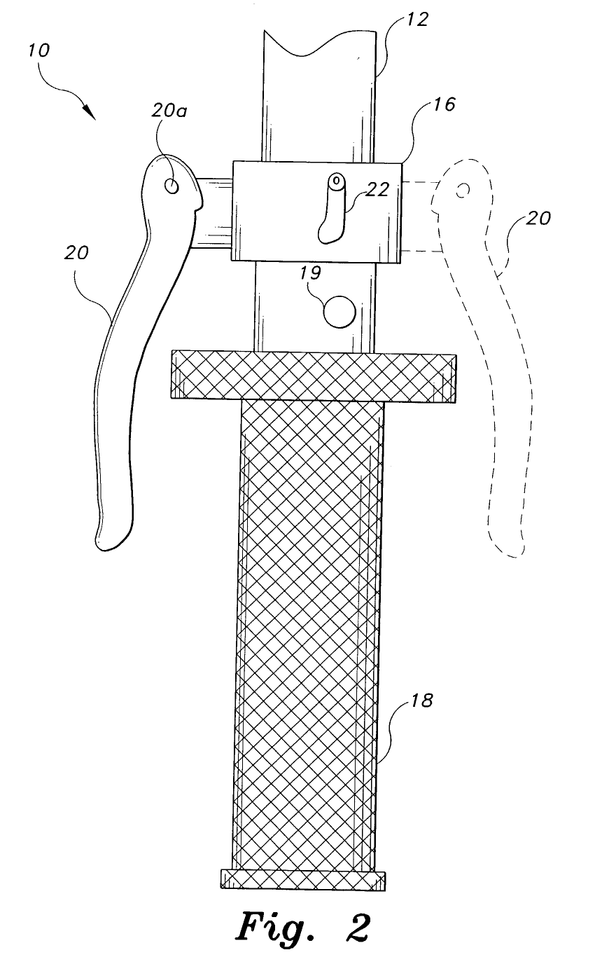

Attention is directed to FIGS. 1 and 2 wherein the dual throttle mechanism of the present invention is generally indicated at 10. As illustrated, the throttle mechanism 10 is mounted on the right handlebar 12 of a jet ski 14. It is obvious that the throttle 10 could be mounted on the left handlebar if desired. The throttle mechanism's mounting bracket 16 is positioned adjacent to and to the inside of handlebar grip 18. A start/stop engine button 19 is interposed between mounting bracket 16 and grip 18. A throttle lever 20 is pivotally mounted at 20a to bracket 16. A control wire (not shown) extends from lever 20 to the throttle of the jet ski engine as known in the art.

Bracket 16 is rotatably mounted on handlebar 12 in a manner that permits a user to move lever 20 to assume a first position (shown in solid lines) wherein the lever is pushed by the thumb of the user. When bracket 16 is rotated, lever 20 assumes a position (shown in phantom lines) whereby the lever is pulled by the fingers of the user. The rotation of bracket 20 is accomplished by utilization of a quick-release locking lever 22. Quick-release locking lever 22 may take on the form of any of the many suitable conventional mechanisms of this type known in the art.

As indicated above, if the user's thumb starts to ache when the lever 20 is in the push position, the user simply employs the start/stop button 19 to stop the jet ski engine. Quick-release lever 22 is moved to its unlocked position; bracket 16 may then be rotated to position lever 20 in a pull position and lever 22 moved to the locked position to firmly secure bracket 16 to the handlebar.

It is to be understood that the present invention is not limited to the embodiment described above, but encompasses any and all embodiments within the scope of the following claims.

I claim:

1. A personal watercraft, comprising:
at least one handle bar secured to said watercraft, said handle bar having a free end;
a handle bar grip defining the free end of said handle bar;
a throttle lever assembly mounted on said handle bar; and
an engine on/off switch disposed on said handle bar, said on/off switch being interposed between said throttle lever assembly and said handle bar grip.

2. A personal watercraft as recited in claim 1, wherein said throttle lever assembly includes a bracket, said throttle lever being attached to said bracket.

3. A personal watercraft as recited in claim 1, wherein said throttle lever assembly includes a bracket, said bracket being mounted for rotatable movement on said handle bar.

4. A personal watercraft as recited in claim 3, further including a quick-release locking mechanism disposed on said bracket, whereby said bracket may be easily released for rotation on said handle bar.

5. A personal watercraft comprising:
at least one handle bar secured to said watercraft, said handle bar having a free end;
a handle bar grip defining the free end of said handle bar;
a throttle lever assembly rotatably mounted on said handle bar, wherein said throttle lever assumes either a first position or a second position; and
an engine on/off switch disposed on said handle bar, said on/off switch being interposed between said throttle lever and said grip.

6. A personal watercraft as recited in claim 5, wherein said first position is a position that permits said throttle lever to be operated by a user's thumb.

7. A personal watercraft as recited in claim 5, wherein said second position is a position that permits said throttle lever to be operated by a user's fingers.

8. A personal watercraft as recited in claim 5, wherein said throttle lever assembly includes a bracket, said throttle lever being attached to said bracket.

9. A personal watercraft as recited in claim 8,further including a quick-release locking mechanism disposed on said bracket, whereby said bracket may be easily released for rotation on said handle bar.

10. A personal watercraft as recited in claim 5, wherein said personal watercraft is a jet ski.
